(19) United States
(12) Patent Application Publication
(10) Pub. No.: US 2006/0266388 A1
(43) Pub. Date: Nov. 30, 2006

(54) Parts Washer

(76) Inventor: Earl Fenton Goddard, Kensington (AU)

Correspondence Address: KLARQUIST SPARKMAN, LLP, 121 SW SALMON STREET, SUITE 1600, PORTLAND, OR, 97204, US

(21) Appl. No.: 10/552,960

(22) PCT Filed: Apr. 16, 2004
(86) PCT No.: PCT/AU04/00502

§ 371 Date: Jul. 10, 2006

(30) Foreign Application Priority Data
Apr. 16, 2003 (AU) 2003901819

(51) Int. Cl. B08B 3/00; B08B 3/12

(52) U.S. Cl. 134/94.1; 134/103.2; 134/137; 134/172; 134/157; 134/151

(57) ABSTRACT

A parts washer having a cleaning chamber and a receptacle into which parts to be cleaned are placed. The receptacle is rotatably mounted within the cleaning chamber and is rotated by a drive device. One or more spray manifolds are provided, each having a plurality of spray jets arranged to spray cleaning fluid onto the parts in the receptacle. The spray manifolds are moveably mounted within the cleaning chamber and are coupled to the drive device such that the drive device causes reciprocating motion of the spray manifolds.

### FIELD OF THE INVENTION

The present invention relates to a parts washer.

### BACKGROUND OF THE INVENTION

Various industries, such as the automotive industry, require a method of cleaning mechanical components which are subject to a build up of dirt, grease and oil. It is known to provide a parts washer in which the components may be placed to be cleaned. Such washers generally include a cleaning chamber into which the parts are placed and a fluid reservoir in which is stored cleaning fluid. A pump is provided to pump the cleaning fluid from the reservoir into the cleaning chamber via jets within the chamber to clean the parts. The cleaning fluid is then returned to the fluid reservoir.

The effectiveness of the parts washer is determined, at least partly, by the pressure of the cleaning fluid from the jets within the chamber. In order to provide higher pressure jets within the chamber, it is necessary to either increase the pressure provided by the pump or to decrease the number of jets. Both of these methods however have limitations. Providing higher pressure from the pump may require changing the pump itself and associated piping, leading to increased costs. Reducing the number of jets is also often not practical as this reduces the area within the parts washer impacted by the jets. An alternative method of increasing the pressure is by decreasing the size of the jets. This, however, can lead to increased likelihood of the jets blocking up.

A method of effectively increasing the pressure of fluid from the jets however would have the advantage of allowing lower strength cleaning agents to be used and/or lower temperatures in the parts washer. This would allow more environmentally friendly cleaning agents to be used and allow more efficient recycling and disposal of the waster water.

The present invention attempts to overcome at least in part the aforementioned disadvantages of previous parts washers.

### SUMMARY OF THE INVENTION

In accordance with one aspect of the present invention there is provided a parts washer comprising:
a cleaning chamber;
a receptacle into which parts to be cleaned are placed, the receptacle being rotatably mounted within the cleaning chamber;
a receptacle drive means arranged to rotate the receptacle; and
one or more spray manifolds, the or each spray manifold having a plurality of spray jets arranged to spray cleaning fluid onto the parts in the receptacle;
wherein the or each spray manifold is moveably mounted within the cleaning chamber and is coupled to a spray manifold drive means such that the spray manifold drive means causes reciprocating motion of the or each spray manifold.

### BRIEF DESCRIPTION OF THE DRAWINGS

The present invention will now be described, by way of example, with reference to the accompanying drawings, in which:

FIG. 1 is a perspective view of a parts washer in accordance with the present invention;

FIG. 2a is a front perspective view of the parts washer of FIG. 1 with the cabinet removed;

FIG. 2b is a rear perspective view of the parts washer of FIG. 2a;

FIG. 3a is a front perspective view of the parts washer of FIG. 1 with the cabinet and basket removed;

FIG. 3b is a rear perspective view of the parts washer of FIG. 3a;

FIG. 4a is a first side view of the parts washer of FIG. 1 with the cabinet and basket removed;

FIG. 4b is a front view of the parts washer of FIG. 4a;

FIG. 4c is a second side view of the parts washer of FIG. 4a;

FIG. 4d is a top view of the parts washer of FIG. 4a;

FIG. 5a is top view of the parts washer of FIG. 1 with the spray manifolds in a first position and with the basket and cabinet removed;

FIG. 5b is a side view of the parts washer of FIG. 5a;

FIG. 6a is top view of the parts washer of FIG. 1 with the spray manifolds in a second position and with the basket and cabinet removed;

FIG. 6b is a side view of the parts washer of FIG. 6a;

FIG. 7a is top view of the parts washer of FIG. 1 with the spray manifolds in a third position and with the basket and cabinet removed; and

FIG. 7b is a side view of the parts washer of FIG. 7a.

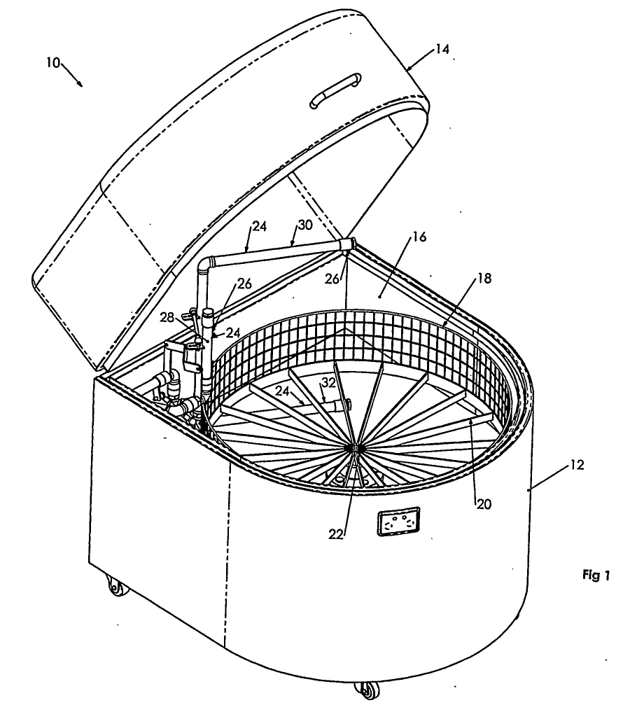

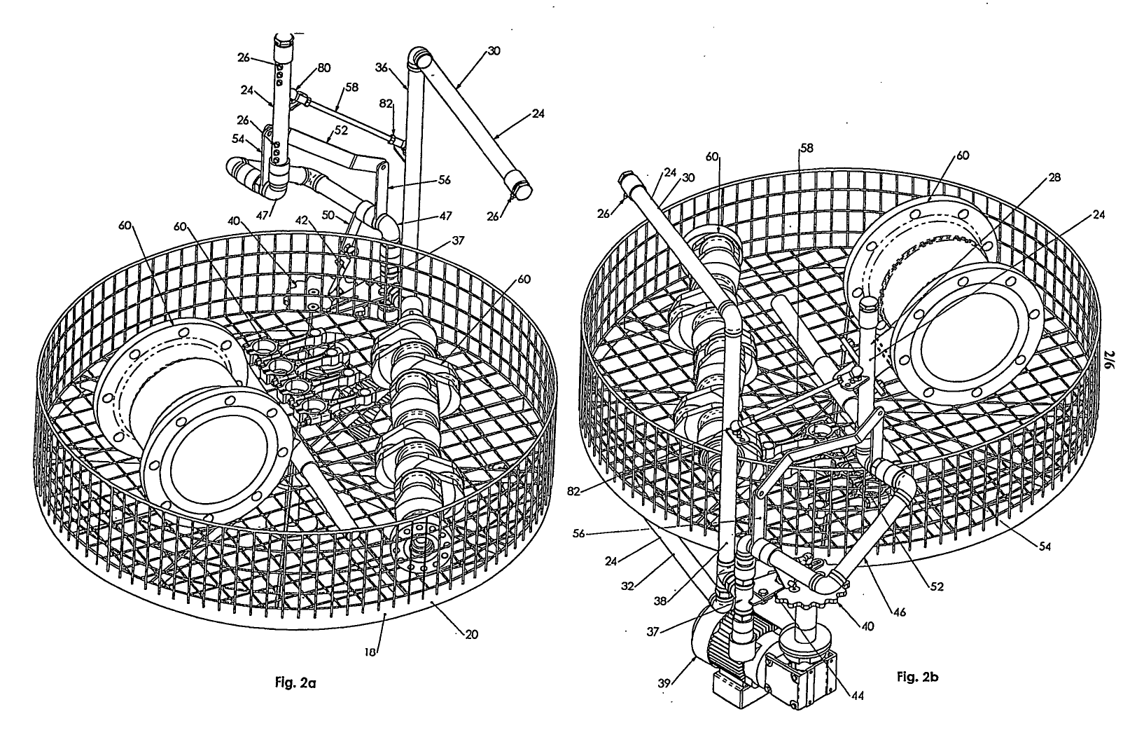

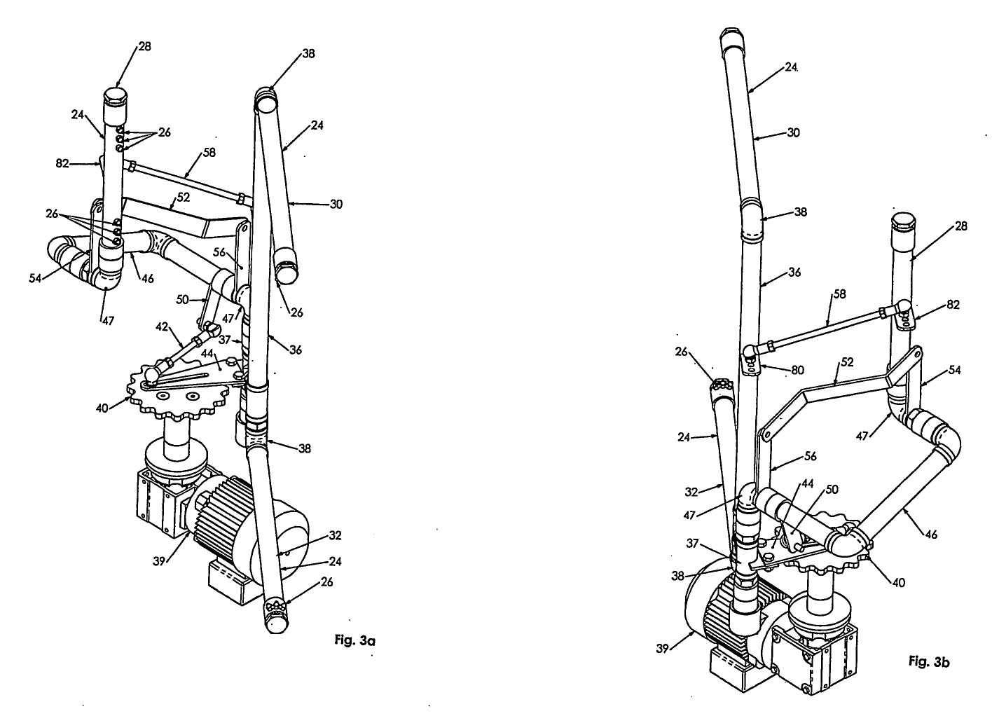

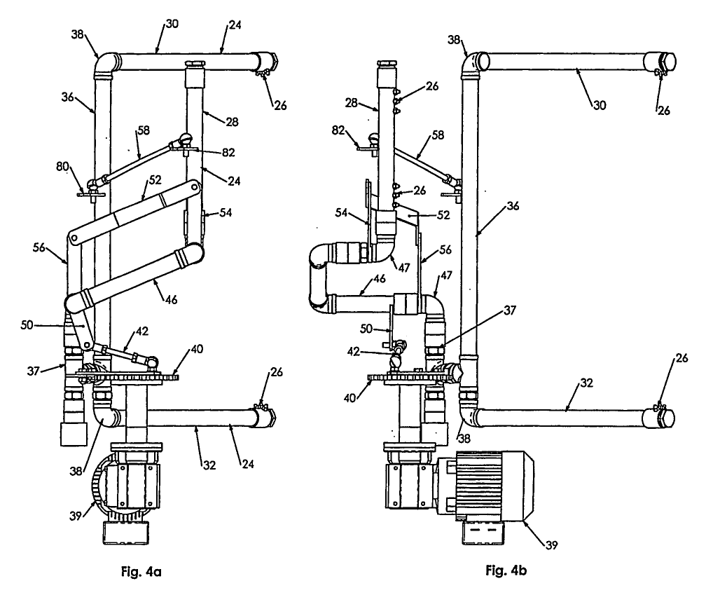

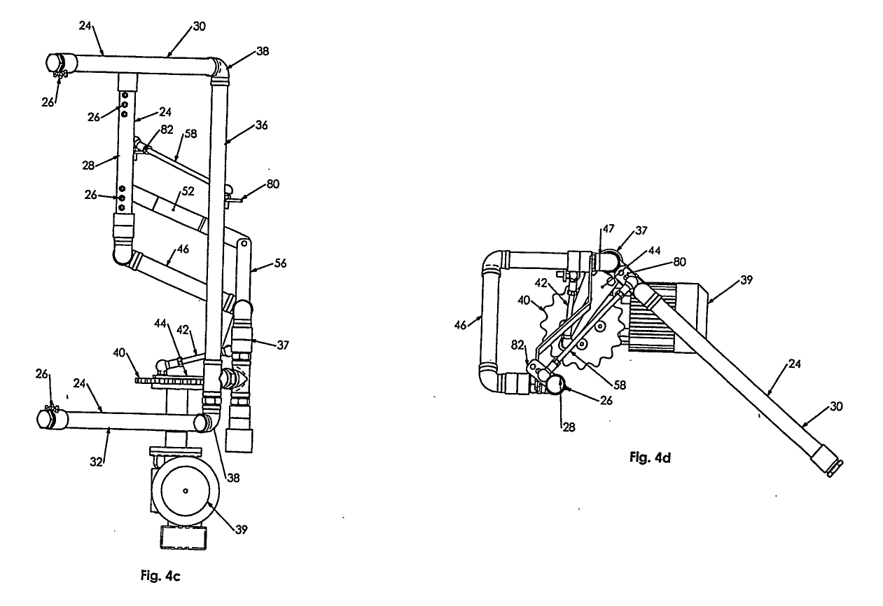

### DESCRIPTION OF THE INVENTION

Referring to the Figures, there is shown a parts washer 10 comprising a cabinet 12 having a lid 14 defining a cleaning chamber 16 within the cabinet 12 when the lid 14 is closed.

The parts washer 10 includes a receptacle 18 rotatably mounted within the cleaning chamber 16. The receptacle comprises a circular basket 20 mounted on a central drive shaft 22. In use, parts 60 which are to be washed by the parts washer 10 are placed within the basket 20.

The parts washer 10 is provided with a receptacle drive means comprising a drive motor (not shown) connected to the drive shaft 22 such that the basket 20 is rotated about the drive shaft 22 in use.

The parts washer 10 includes a plurality of spray manifolds 24 having spray jets 26 thereon. In the embodiment shown in the drawings, the parts washer 10 includes a vertical spray manifold 28 and first and second horizontal spray manifolds 30 and 32. The vertical spray manifold 28 is arranged adjacent a side of the basket 20 with the spray jets 26 arranged to spray cleaning fluid in a generally horizontal direction towards the basket 20. The first horizontal spray manifold 30 is located above the basket 20 with the spray jets 26 arranged to spray cleaning fluid generally vertically downward towards the basket 20. The second horizontal spray manifold 32 is located below the basket 20 with the spray jets 26 arranged to spray cleaning fluid generally vertically upward towards the basket 20.

In the embodiment shown, each of the first and second horizontal spray manifolds 30 and 32 includes three spray jets 26 at an outer end thereof. Three spray jets 26 are provided at the upper end of the vertical spray manifold 28 and three spray jets are provided at the lower end of the vertical spray manifold 28.

Each of the spray jets 26 sprays a solid jet of cleaning fluid onto parts 60 in the basket 20. That is, the spray jets 26 spray cleaning fluid in a stream that does not diverge in the manner of known ‘fan’ jets. Further, each set of three spray jets 26 is arranged such that the spray jets 26 are directed in different directions. In the embodiment shown, each set of three spray jets 26 is arranged such that the central jet 26 is sprayed in a direction perpendicular to the spray manifold 24 with the outer two spray jets 26 angled away from the central jet 26 in a single plane. The use of multiple non-parallel, solid spray jets 26 provides for better cleaning of parts 60 with complex surface shapes.

The first and second horizontal spray manifolds 30 and 32 comprise pipes joined by an interconnecting manifold 36 arranged to extend alongside the basket 20 generally vertically between first ends 38 of the first and second horizontal spray manifolds 30 and 32. Also provided is an inlet manifold 37 which is provided with pressurised cleaning fluid from a fluid pump (not shown). The inlet manifold is in fluid communication with the first and second horizontal spray manifolds 30 and 32 and the vertical spray manifold 28 such that each of the spray manifolds 24 is supplied with pressurised cleaning fluid. The fluid pump recirculates cleaning fluid which collects in the bottom of the cleaning chamber 16 back through the spray manifolds 24.

The inlet manifold 37 is arranged generally vertically and is connected to and in fluid communication with the interconnecting manifold 38. A lower end of the inlet manifold 37 is connected to the fluid pump and an upper end of the inlet manifold 37 is connected to a lower end of the vertical spray manifold 28 by a generally U-shaped pipe 46. The lower end of the vertical spray manifold 28 and the upper end of the inlet manifold 27 are each provided with a ninety degree elbow 47 such that the U-shaped pipe 46 extends in a generally horizontal direction from both the vertical spray manifold 28 and the inlet manifold 37. Also, the ends of the U-shaped pipe 46, the upper end of the inlet manifold 37 and the lower end of the vertical spray manifold 28 are rotatably received within the elbows 47.

Also provided is a spray manifold drive means for causing reciprocating movement of the spray manifolds 24. The spray manifold drive means comprises a motor 39 arranged to rotate a drive wheel 40 about a generally vertical axis.

The drive wheel 40 is provided with a first cam member in the form of acam plate 44 connected between a point on the drive wheel offset from the axis of rotation of the drive wheel 40 and the inlet manifold 37. The connection between the cam plate 44 and the drive wheel 40 is via a lug on the drive wheel 40 which is received in a slot 45 in the cam plate 44. Rotation of the drive wheel 40 thereby causes the inlet manifold 37 to undergo reciprocating rotation about its longitudinal axis. The interconnecting manifold 38 also therefore undergoes reciprocating rotational movement, thereby causing the first and second horizontal spray manifolds 30 and 32 to undergo reciprocating horizontal motion through an arc.

The drive wheel 40 is also provided with a second cam member in the for of a cam rod 42 connected between the lug on the drive wheel 40 and a first transverse bracket S0 extending from the U-shaped pipe 46 adjacent the inlet manifold 37. The cam rod 42 is pivotally connected to the first transverse bracket 50 such that rotation of the drive wheel 40 causes the U-shaped pipe 46 to undergo reciprocating rotational movement about the longitudinal axis of the connection to the elbow 47.

In order to maintain the vertical spray manifold 28 in a generally vertical orientation, a first interconnecting member 52 is provided. The first interconnecting member 52 is pivotally connected at a first end to a second transverse bracket 54 arranged to extend generally vertically from the U-shaped pipe 46 adjacent the vertical spray manifold 28. The first interconnecting member 52 is pivotally connected at a second end to a third transverse bracket 56 arranged to extend generally vertically from the U-shaped pipe 46 adjacent the inlet manifold 37. The reciprocating rotational motion of the U-shaped pipe 46 about the connection to the elbow 47 at the inlet manifold 37 is therefore translated to vertical reciprocating linear motion of the vertical spray manifold 28 along its longitudinal axis.

Also provided is a second interconnecting member 58 connected between the vertical spray manifold 28 and the interconnecting manifold 38. The second interconnecting member 58 is connected between a fourth transverse bracket 80 on the interconnecting manifold 38 and a fifth transverse bracket 82 on the vertical spray manifold 28. The second interconnecting member 58 causes the reciprocating rotational movement of the interconnecting manifold 38 about its longitudinal axis to be translated to the vertical spray manifold 28. The vertical spray manifold 28 also thereby undergoes reciprocating rotational movement about its longitudinal axis.

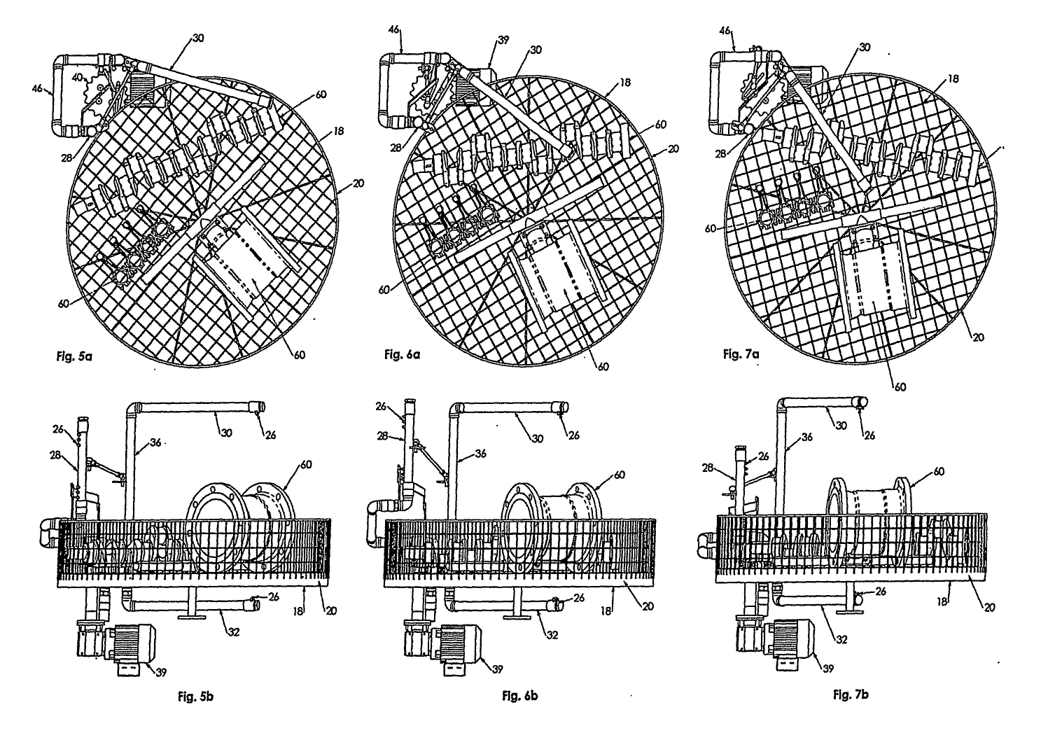

Referring to FIGS. 5 to 7, the reciprocating motion of the spray manifolds 24 can be seen. In FIGS. 5a, 6a and 7a, the horizontal reciprocating pivotal motion of the horizontal spray manifolds 30 and 32 can be seen. In FIGS. 5b, 6b and 7b, the linear longitudinal reciprocating motion and the rotational reciprocating motion (which can be seen by reference to the position of the spray jets 26) of the vertical spray manifold 28 can be seen.

In use, the parts 60 to be cleaned are placed within the basket 20 of the parts washer 10 and the lid 14 is closed. The drive motor is activated to rotate the basket 20. The pump is also activated to supply cleaning fluid to the first and second horizontal spray manifolds 30 and 32 and the vertical spray manifold 28. The rotation of the drive wheel 40 causes horizontal reciprocating motion of the first and second horizontal spray manifolds 30 and 32 and reciprocating motion of the vertical spray manifold 28. The movement of the spray manifolds 24 allows all of the areas of the basket 20 to be impacted by the cleaning fluid during rotation of the basket 20.

The relative speeds of rotation of the basket 20 and the drive wheel 40, or other means may be used to determine the spray pattern generated over the basket 20. The parts washer 10 would be arranged such that after a single revolution of the basket 20, the spray manifolds 24 have undergone slightly more or slightly less than an intenger number of recriprocal movements. That is, during one rotation of the basket 20, the drive wheel 40 has rotated from a starting position through a number of revolutions to a position slightly offset from the starting position. In this way, the spray jets 26 impact on a different position on the parts 60 on each rotation of the basket 20.

The use of reciprocating motion of the spray manifolds 24 allows the use of solid cleaning jets as described previously with all of the area within the basket 20 still being impacted by the jets 26. The use of solid spray jets 26 provides better cleaning due to the increased pressure at which the cleaning fluid strikes the parts 20. This results in a number of possible benefits. Firstly, the increased pressure of the jets 26 allows for the use of a smaller pump size and reduces the incidence of blockages in the jets. Also, the improved cleaning results in decreased wash cycle times and allows for the use of lower strength detergents. For example, non-emulsifying detergents can be used, which would allow more efficient collection of the oil from the cleaning fluid and therefore increased life of the cleaning fluid and easier, more cost effective disposal. Further, the reduced wash cycle times means less energy usage and reduces the temperature rise of the parts being washed resulting in the parts being safer to handle.

Modifications and variations as would be apparent to a skilled addressee are deemed to be within the scope of the present invention

1. A parts washer comprising:
a cleaning chamber;
a receptacle into which parts to be cleaned are placed, the receptacle being rotatably mounted within the cleaning chamber;
a receptacle drive device arranged to rotate the receptacle; and
at least one spray manifold, the at least one spray manifold having a plurality of spray jets arranged to spray cleaning fluid onto the parts in the receptacle;
wherein the at least one spray manifold is moveably mounted within the cleaning chamber and is coupled to a spray manifold drive device such that the spray manifold drive device causes reciprocating motion of the at least one of the spray manifold.

2. A parts washer in accordance with claim 1, characterised in that the at least one spray manifold comprises at least one horizontal spray manifold arranged to undergo reciprocal horizontal movement and to spray cleaning fluid in a generally vertical direction and at least one vertical spray manifold arranged to undergo reciprocal vertical motion and to spray cleaning fluid in a generally horizontal direction.

3. A parts washer in accordance with claim 2, characterised in that there is provided a first horizontal spray manifold located above the receptacle having spray jets directed downwardly toward the receptacle and a second horizontal spray manifold located below the receptacle having spray jets directed upwardly toward the receptacle.

4. A parts washer in accordance with claim 3, characterised in that the first and second horizontal spray manifolds are connected adjacent first ends thereof to an interconnecting manifold arranged to extend generally vertically between the first and second horizontal spray manifolds.

5. A parts washer in accordance with claim 4, characterised in that the interconnecting manifold is engaged by the spray manifold drive device so that the interconnecting manifold undergoes rotational reciprocal motion about a longitudinal axis of the interconnecting manifold, thereby causing the first and second horizontal spray manifolds to undergo pivotal reciprocal motion in a generally horizontal plane.

6. A parts washer in accordance with claim 2, characterised in that a vertical spray manifold is provided, the vertical spray manifold being engaged by the spray manifold drive device such that the vertical spray manifold undergoes reciprocal linear movement along a vertical axis.

7. A parts washer in accordance with claim 1, characterised in that each of the spray jets sprays a solid, non-diverging stream of cleaning fluid.

8. A parts washer in accordance with claim 7, characterised in that the spray jets on each of the spray manifold are directed to spray at varying angles in a single plane.

9. A parts washer in accordance with claim 2, characterised in that the or each horizontal spray manifolds is provided with a plurality of spray jets at an outer end thereof.

10. A parts washer in accordance with claim 2, wherein the at least one spray manifold is provided with a plurality of spray jets at an upper end thereof and a plurality of spray jets at a lower end thereof.

11. A parts washer in accordance with claim 1, characterised in that the spray manifold drive device and receptacle drive device are arranged such that after a single revolution of the receptacle, the at least one spray manifold will have undergone a plurality of reciprocal movements and be in a position offset from the position of the at least one spray manifold at the commencement of said revolution.

12. A parts washer in accordance with claim 4, characterised in that the spray manifold drive device comprises a motor arranged to drive a drive wheel and a first cam member is provided connected between the drive wheel and the interconnecting manifold such that the rotation of the drive wheel causes the interconnecting manifold to undergo said rotational reciprocal motion.

13. A parts washer in accordance with claim 12, characterised in that an inlet manifold is provided, the inlet manifold being arranged generally vertically and being connected to and in fluid communication with the interconnecting manifold, the first cam member being connected between the drive wheel and the inlet manifold.

14. A parts washer in accordance with claim 13, characterised in that the first cam member comprises a cam plate having a slot adjacent a first end to engage with an off-centre lug on the drive wheel and being connected at a second end thereof to the inlet manifold.

15. A parts washer in accordance with claim 13, characterised in that a U-shaped pipe is provided, the U-shaped pipe being rotatably connected between an elbow on the inlet manifold and an elbow on the vertical spray manifold such that the U-shaped pipe extends generally horizontally at ends thereof and a second cam member being provided connecting between the drive wheel and the U-shaped pipe adjacent the inlet manifold such that rotation of the drive wheel causes the U-shaped pipe adjacent the inlet manifold to undergo reciprocal rotational movement about the longitudinal axis of U-shaped pipe adjacent the inlet manifold.

16. A parts washer in accordance with claim 15, characterised in that the second cam member comprises a cam rod connected at a first end thereof to the off centre lug on the drive wheel and pivotally at a second end thereof to a first transverse bracket on the U-shaped pipe adjacent the inlet manifold.

17. A parts washer in accordance with claim 16 wherein a first interconnecting member is provided, the first interconnecting member being pivotally connected between a second transverse bracket on the U-shaped pipe adjacent the inlet manifold and a third transverse bracket on the U-shaped pipe adjacent the vertical spray manifold such that rotation of the drive wheel causes the vertical spray manifold to undergo vertical linear reciprocal movement along the longitudinal axis of the vertical spray manifold.

18. A parts washer in accordance with claim 17, characterised in that a second interconnecting member is provided, the second interconnecting member being pivotally connected between a fourth transverse bracket on the interconnecting manifold and a fifth transverse bracket on the vertical spray manifold, such that the rotational reciprocal motion of the interconnecting manifold causes rotational reciprocal motion of the vertical spray manifold about the longitudinal axis of the vertical spray manifold.

19. A parts washer in accordance with claim 1, characterised in that the cleaning chamber comprises a cabinet having a lid moveable between an open position and a closed position.

20. A parts washer in accordance with claim 1, characterised in that the receptacle comprises a basket mounted on a central drive shaft.
